(19) United States
(12) Patent Application Publication
(10) Pub. No.: US 2013/0075174 A1
(43) Pub. Date: Mar. 28, 2013

(54) Vehicle kinetic energy utilization transmission system

(71) Applicant: John Jones, JR., Delray Beach, FL (US)

(72) Inventor: John Jones, JR., Delray Beach, FL (US)

(21) Appl. No.: 13/200,667

(22) Filed: Sep. 28, 2011

(51) Int. Cl. B60K 6/10

(52) U.S. Cl. 180/165

(57) ABSTRACT

A standard change gear transmission is separated from a vehicle's engine by a compact modulator having modulator rotor, modulator stator/flywheel, and a fixed modulator induction coil. Upon application of the vehicle's braking mechanism, the modular flywheel selectively and independently delivers vehicle kinetic energy to the transmission by means of an extended, clutched transmission or modulator shaft.

### FIELD OF THE INVENTION

The present invention relates to an efficient, compact transmission system for the capture, conservation, and re-utilization of otherwise wasted accumulated kinetic energy, resulting from vehicle deceleration.

### BACKGROUND OF THE INVENTION

Motorized ground based wheeled vehicles capable of substantial velocity accumulate significant, essentially linear, kinetic energy during their operation. The achievement of this kinetic energy requires the expenditure of comparatively greater energy units of fuel in order to overcome inertial forces which tend to restrain the mass of the vehicle. Conversely, the attained energy of the mass-velocity is totally lost to the heat of braking and other unrecoverable retardant forces in each velocity deceleration cycle.

Capture of linear kinetic energy resulting from deceleration sources, by use of absorbed flywheel energy, has been attempted with limited success. There have been systems which attempt to overcome the problems of utilizing a workable flywheel energy conservation system by the introduction of continuously variable-ratio transmissions into the power flow path. While working models exist of such systems, they have severe limitations as to size, drag, efficiency, durability, and complexity. That such transmissions are needed is predicated upon the fact that in either power flow direction, the source of energy is caused to lose speed as it transfers energy to the opposing body, either the flywheel to vehicle or the vehicle to the flywheel. In order to work, the system must overcome this physical reality, that is a first mass traveling at an initial velocity, while being drained of energy and thus slowing, must continue to accelerate a second mass. This result must be accomplished while the mass velocity of the first mass, the vehicle, is being used to accelerate the second mass, the flywheel, and conversely while the mass velocity of the flywheel is being used to accelerate the vehicle.

U.S. Pat. No. 7,931,107 discloses a system which successfully converts a vehicle's linear kinetic energy, following vehicle deceleration, for short period storage and then recaptures much of this energy by reconverting it into linear velocity by returning it to reaccelerate the vehicle. Among other changes, the current invention utilizes these principles in employing a eddy current/flywheel modulator system which increases the overall limits of input/output torque and rotational speeds, reduces system complexity and improves overall efficiency.

### SUMMARY OF THE INVENTION

It is thus the object of the present invention to provide a kinetic energy transfer system which utilizes a unique flywheel modulator component in combination with a prime mover and common vehicle change gear transmission. The system expands the vehicle's overdrive gear range by the downshifting of the transmission upon vehicle deceleration.

More specifically, a change gear transmission is separated from the vehicle's engine or prime mover by a compact modulator, comprising a modulator rotor, modulator flywheel/stator, and fixed modulator induction coil. The prime mover and the modulator flywheel selectively and independently deliver power to the transmission by means of an extended, clutched transmission shaft or modulator shaft.

During vehicle deceleration, the engine is clutch-disconnected from its transmission. In this cycle, with the modulator as the interface between the kinetic energy of the vehicle and the flywheel, the modulator enables the uninterrupted run-up of flywheel speed by managing torque flow. This process, which begins initially from the lowest transmission gear ratio (highest gearing) attained by the vehicle immediately before commencement of the deceleration cycle, progresses, in turn, by downshifting through each subsequent higher ratio gear paring of the vehicle transmission. Vehicle transmission gear ratios progress toward or exceed a 1:1 gear-pairing ratio as the vehicle speed advances. The inverse gearing relationship is implicit here when downshifting such a transmission. Through such downshifting, the input shaft speed to the modulator and thus flywheel will be sustained at the highest possible level for the longest possible time as the vehicle speed declines, as a result of the action of the flywheel on the vehicle. The modulator, by electronically managing torque throughput, enables these actions to be accomplished smoothly and efficiently and with no abnormal vibration.

During the return of kinetic energy to the vehicle by the flywheel through the modulator, the above operations are reversed in the operational sense. However, unlike the deceleration cycle where the prime mover has to be taken out of the equation to prevent energy drag, the prime mover power may selectively be added as desired in a manner such that both the engine and the flywheel contribute to advancing the acceleration of the vehicle. In this format, through the operation of clutch features, the prime mover is prevented from detracting from the performance and efficiency of the modulator.

The system is disclosed as being utilized in two configurations. The first is a direct in-line configuration in which the prime mover, power shaft, modulator unit and vehicle change gear transmission are aligned and mounted on a transmission shaft. The second is an indirect, off-set power configuration in which the modulator unit is mounted on a modulator shaft, interconnected by off-set transmission shafting. The vehicle gear change transmission and the prime mover shaft are positioned on the off-set transmission shafting, so as to accommodate a power connection, joining the transmission input shaft to the modulator shaft.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the components of the in-line configuration system of the present invention.

FIG. 2 shows the components of the off-set configuration system of the present invention.

### DETAILED DESCRIPTION OF THE INVENTION

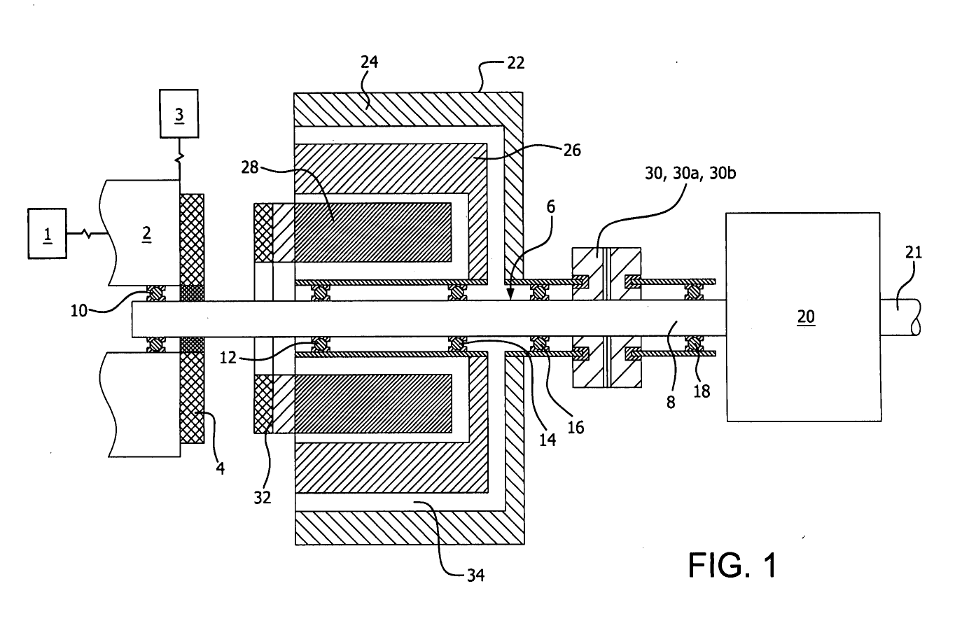

FIG. 1 shows the in-line configuration of the kinetic energy utilization transmission system of the present invention. The power output from vehicle prime mover 1 operates through prime mover shaft 2. Prime mover shaft is ordinarily the output of the crankshaft.

Prime mover clutch 4 is an on/off mechanism which provides selective engagement of the output from the prime mover to vehicle transmission shafting 6. Vehicle transmission shafting 6 as depicted in this in-line configuration, comprises transmission shaft 8 and supporting bearings, 10, 12, 14, 16, and 18. Prime mover clutch 4 allows for the disengagement of prime mover 1 from transmission shaft 8 at times of vehicle deceleration, so as to prevent kinetic energy losses by prime mover compression braking, communicated by way of prime mover shaft 2.

Transmission shaft 8 is, effectively, an extended input power shaft to the vehicle transmission. As shown in FIG. 1, transmission shaft 8 is supported at prime mover shaft 2 by bearing 10 at one end and communicates with vehicle change gear transmission 20, further described hereinafter.

Bearings 12, 14, 16, and 18 facilitate the mounting of modular unit 22 of the present invention which comprises modulator rotor 24, modular stator/flywheel 26, and fixed modulator induction coil 28. These bearings also facilitate the mounting of modulator rotor clutch 30, comprising fluid coupling 30a and planetary overdrive gear 30b. Modulator rotor clutch 30 is mounted on and selectively engages or disengages transmission shaft 8 to modulator rotor 24 of modulator unit 22. The fluid coupling within modulator rotor clutch 30 serves to rotate modulator rotor 24 and synchronize it at the same approximate speed as transmission shaft 8, thus preventing shock at power engagement of the modulator rotor clutch. When modulator rotor clutch 30 is engaged upon vehicle deceleration, torque, powered by vehicle mass velocity, is conducted to modulator rotor 24 through the planetary overdrive gear at the modulator rotor clutch which, being of a step-up gear arrangement in this power flow direction, increases the rotational input speed accordingly from transmission shaft 8 to the modular rotor.

Flywheel 26, within modulator unit 22, is free to rotate at will on bearings 12 and 14. When modulator rotor clutch 30 is selectively engaged and modulator induction coil 28 is energized to throughput torque via inductive forces, modulator rotor 24 functions to communicate torque to and from transmission shaft 8 to one side, and the bearing supported flywheel 26 to the other side.

Modulator coil 28, fixed in place by mounting coil bracket 32, is supplied with a fully controllable voltage which ranges through infinite increments in the range from zero to coil maximum. The variable, magnetic or inductive energy field generated by this coil is arranged to pass through to modulator rotor 24. In so doing, the inductive field passes through modulator flywheel 26 and air gap 34 between the flywheel and modulator rotor 24. As coil voltage is raised, the inductive field flows across air gap 34. Rotation of modulator rotor 24 cuts this inductive field which, when generated, causes the two induction responsive rotatable, but independent members, i.e. modulator rotor 24 and modulator flywheel 26, to rotate in tandem. The magnetic or inductive attraction generated between modulator rotor 24 and modulator flywheel 26 is proportional to the voltage across fixed modulator induction coil 28. Thus, modulator unit 22, comprised of modulator rotor 24, modulator flywheel 26, and modulator induction coil 28, transmits torque in direct proportional strength to the coil voltage. Since a full range of infinitely variable torque transmission is possible, from zero torque at zero voltage through to the maximum torque at maximum coil voltage, the system forms an infinitely variable torque transmission.

It is noted that modulator flywheel 26 serves two functions, that of an electrical induction stator and that of an energy stage device, i.e. a flywheel. As previously discussed, flywheel 26 is mounted on transmission shaft 8 by means of bearings 12 and 14 and is free to rotate, as it is otherwise unattached to any other components. Flywheel 26 is under the selective control of the infinitely variable induction field governed by modulator induction coil 28. As there are no rigid elements attached or attachable to flywheel 26, it is not subject to external shock or vibration. Operationally, it is only under the influence of induction forces which are infinitely variable between zero coil voltage and the maximum coil voltage.

Vehicle change gear transmission 20, commonly used in vehicles, offers a selective range of high gear to low gear ratio relationships between the prime mover and the vehicle. It functions as a conventional transmission at all times when prime mover clutch 4 is communicating power to transmission shaft 8 and when modulator flywheel 26 is providing torque via induction to modulator rotor 24, and an engaged modulator rotor clutch 30 is communicating power to transmission shaft 8.

However, when prime mover clutch 4 is disengaged, a power flow path may be selectively created which conducts any available system torque to or from vehicle change gear transmission 20 through to output drive shaft 21, by way of transmission shaft 8, modulator rotor clutch 30 with its planetary overdrive gear 30b, modulator rotor 24, and modulator flywheel 26, via applied induction created by modulator induction coil 28. In this case, vehicle change gear transmission 20 offers selectively upward and downward ranging high to low and low to high gear ratios directed to or from the vehicle mass and modulator flywheel 26 mass. In one setting, rotational shaft speed from the vehicle in the direction of modulator flywheel 26 is multiplied, while on being returned, torque from the modulator flywheel may be selectively amplified in the direction of the vehicle.

Immediately prior to braking, the vehicle's transmission is operating in high gear. The inventive system is not operational as modulator rotor clutch 30 is not engaged. However, upon actuation of the vehicle's braking mechanism 3, engine output decreases and prime mover clutch 4 is disengaged. Modulator rotor clutch 30 is engaged, directing power flow to modulator unit 22, and specifically to modulator rotor 24. Simultaneously with the engagement of modulator unit 22 by modulator rotor clutch 30, coil voltage in modulator induction coil 28 is cycled from zero to maximum voltage. As the coil voltage is raised, the variable magnetic or inductive or energy field created by modulator induction coil 28 flows across air gap 34. Rotation of modulator rotor 24, acting through the inductive energy field flowing through air gap 34 acts on modulator flywheel 26, causing the modulator flywheel to rotate in tandem with the modulator rotor 24.

Also upon braking demand and in conjunction with the engagement of modulator unit 22, vehicle change gear transmission 24 continually downshifts to the next lowest gear, simultaneously with modulator unit 22, to zero coil voltage. The overdrive effect of vehicle change gear transmission 20 downshifting to its next lower transmission gear is transferred to modulator unit 22 which, after cycling back to zero, again recycles up to maximum voltage. The steps of this process are repeated with each downshifting of transmission ratios.

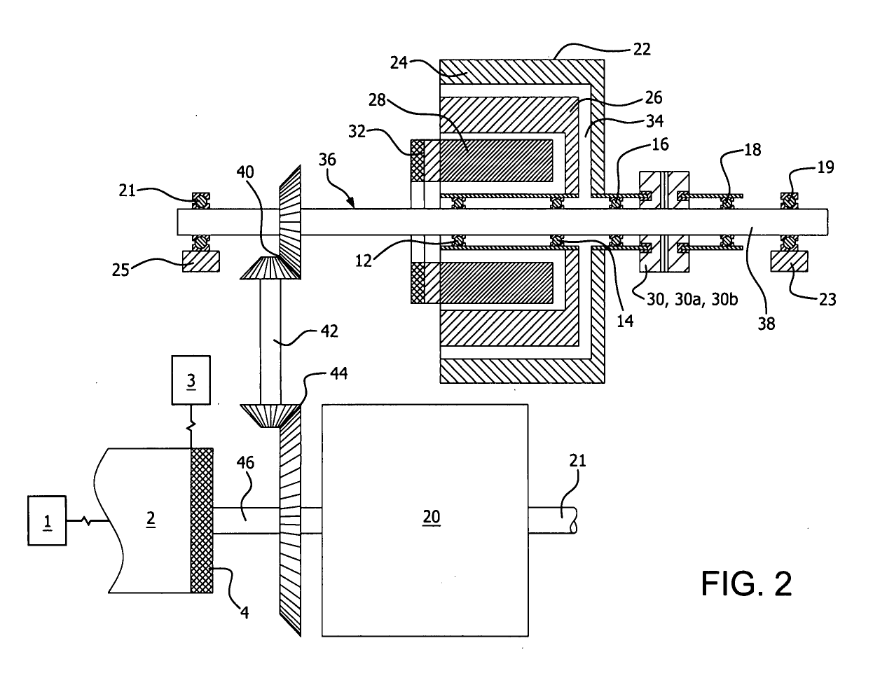

FIG. 2 shows the off-set configuration of the kinetic energy utilization transmission system of the present invention. Modulator unit 22 is identical to that which was described with regard to the in-line configuration. However, in the herein off-set configuration, modulator unit 22 and vehicle change gear transmission 20 are interconnected by off-set vehicle transmission shafting 36 compromising, modulator shaft 38, gearing 40, intermediate shaft 42, gearing 44, and vehicle transmission shaft 46. In this configuration, modulator unit 22 is supported on modulator shaft 38, and is similar function to transmission shaft 8 as it relates to modulator unit 22 in the first configuration However, here modulator unit 22 itself independently supported on bearings 19 and 21 on supports 23 and 25 respectively, separate from vehicle change gear transmission 20. By this configuration, modulator unit 22 exchanges energy by means of vehicle transmission shafting interconnected with vehicle change gear transmission 20.

The power mechanism disclosed in the off-set system may be of a gear pairing, as shown, or other such connection which affords the capability to interpose a 1:1 or other desirable gearing ratio between vehicle transmission shaft 46 and the remotely positioned modulator shaft 38. As an example, in slow speed truck operation, it may be desirable to interpose gearing of some significant overdrive ratio in order to more substantially accelerate, despite low vehicle speed, the energy storage component, modulator flywheel 26, thereby capturing significant kinetic energy from the truck mass. Conversely, on returning modulator flywheel 26 energy, torque is advantageously amplified by this same gearing technology.

Similarly, in addition to the stop and go operation of the system, in the interpositioning of modulator unit 22 between prime mover 1 and vehicle change gear transmission 20, the off-set configuration enables “slow and go” operation as well. “Slow and go” is defined as vehicular traffic of a nature where speeds are slowed, but not stopped and then reaccelerated, as is commonly encountered in heavy highway traffic. This is achieved through the combination and cooperation of vehicle change gear transmission 20 and modulator unit 22.

As described and shown in FIG. 2, an off-set power configuration is made between one end of modulator shaft 38 and vehicle transmission shaft 46. This connection is made in a position between prime mover clutch 4 and vehicle change gear transmission 20. As with the in-line configuration, this power flow path also provides for the exploration of the advantageous use of speed and torque options offered by the step-up/step-down operational features intrinsic to vehicle change gear transmission 20. Both the in-line and off-set configurations utilize prime mover shaft clutch 4 which performs the identical functions in each system.

Also as is shown in FIG. 2, prime mover shaft clutch 4 is interposed between prime mover shaft 2 and vehicle transmission shaft 46 to vehicle change gear transmission 20, such that the engine may selectively power the transmission shaft upon vehicle acceleration, but which may selectively isolate prime mover shaft 2 from the transmission shaft on vehicle deceleration. The off-set configuration also provides a method for connecting any second power receiving or emitting auxiliary machine into the change-gear transmission power-flow path of a motor vehicle. These machines may be but are not limited to, a motor, power generator, power alternator, continuously variable transmission, infinitely variable transmission, flywheel system, etc. It is envisioned that such a device could be connected to vehicle transmission shaft 3 such that it would received power therefrom upon vehicle deceleration and deliver energy thereto on vehicle reacceleration and/or restart the engine via prime mover clutch 4 to effect “start-stop” vehicle operation when needed. It could also provide power to vehicle systems as needed during the engine off cycle. In addition, such an arrangement may be used to access power from the prime mover via prime mover clutch 4 for other purposes, such as to power pumps.

In the above situation where an alternator or motor/generator may be connected, an electric power storage battery may be used to receive and store energy on vehicle deceleration and return such energy to the vehicle on reacceleration through the same or other path. It may also capture residual otherwise stored or unstored kinetic energy which may be available from modulator flywheel 26 or from the vehicle, respectively. In these situations, residual (or unused primary) energy is considered to be that which is left over after the main energy has been accounted for by being transferred to modulator flywheel 26 or to the vehicle during the main energy transfer phases of deceleration and reacceleration of the respective masses.

It is significant that at residual energy levels, at which point there may not be adequate energy for effective mechanical transfer between the masses, there will be adequate energy sufficient to, for example, charge a battery. This energy can find many uses, such as powering vehicle air conditioning while facilitating “stop-start” vehicle engine operation. Other systems may be advantageously connected to vehicle transmission shaft 46 through this method to thereby receive or deliver power or other data.

It is further anticipated that a second induction coil may be positioned in the vicinity of the modulator flywheel 26 to form an independent electric generator for the selective generation of electrical current for optional utilization. Such electronic part and controls, as may be required, are also envisioned.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A kinetic energy utilization transmission system for providing auxiliary power to a motor vehicle having a prime mover, a prime mover shaft, a vehicle change gear transmission having a range of high to low gear ratios, vehicle transmission shafting, and a braking mechanism, said system comprising:
modulating means for receiving vehicle deceleration data upon actuation of the braking mechanism and, upon actuation of the braking mechanism, for rotating the vehicle transmission shafting, said modulating means being mounted on the vehicle transmission shafting, the vehicle transmission shafting interconnecting the modulating means, the prime mover shaft, and the vehicle change gear transmission; and
clutch means for the engagement and disengagement of the modulating means and for rotating the modulating means, whereby upon actuation of the braking mechanism, the modulating means is accelerated by the step-by-step downshifting from said high to low gear ratios of the vehicle change gear transmission, to provide auxiliary power to the vehicle in the form of kinetic energy.

2. The kinetic energy utilization transmission system as in claim 1 wherein the modulating means comprises a modulating rotor rotatably engaged by the clutch means and flywheel means in spaced relation to the modulator rotor for the storage of the kinetic energy to be inputted to the vehicle via the vehicle change gear transmission.

3. The kinetic energy utilization transmission system as in claim 2 whereby the modulating means is configured such that rotation of the modulator rotor causes the flywheel means to rotate in tandem with the modulator rotor.

4. The kinetic energy utilization transmission system as in claim 2 wherein the modulating means further comprises modulator induction means for providing inductive energy to the modulating means.

5. The kinetic energy utilization transmission system as in claim 3 wherein the modulating means further comprises modulator induction means for providing inductive energy to the modulating means, the inductive energy provided by the induction means causing the rotation of the flywheel means in tandem with the modulator rotor

6. The kinetic energy utilization transmission system of claim 4 whereby the modulating means is configured such that the inductive energy provided by the induction means results in the rotation of the flywheel means in tandem with the modulator rotor.

7. The kinetic energy utilization transmission system as in claim 1 wherein said modulating means is an integral unit having a rotatable modulator rotor rotatably engaged by the clutch means, a fixed modulator induction coil for providing inductive energy to the modulating means, and a free floating flywheel located in spaced relation to and between the modulator rotor and the modulator induction coil.

8. The kinetic energy utilization transmission system as in claim 7 further comprising an air gap between the modulator rotor and the modulator induction coil, wherein inductive energy from the modulator inductor coil flows across the air gap to the modulator rotor, causing the rotation of the flywheel in tandem with the modulator rotor.

9. The kinetic energy utilization transmission system as in claim 1 wherein the vehicle transmission shafting comprises a transmission shaft, the modulating means being mounted on the transmission shaft between the prime mover shaft and the vehicle change gear transmission, such that the vehicle change gear transmission, the clutch means, the modulating means and the prime mover shaft are positioned in an in-line configuration.

10. The kinetic energy utilization transmission system as in claim 1 wherein the vehicle transmission shafting comprises a modulator shaft and interconnected off-set transmission shafting, the modulating means and clutch means being mounted on the modulator shaft and the vehicle change gear transmission and prime mover shaft being interconnected with the off-set transmission shafting, the modulating means and the clutch means, and the vehicle change gear transmission and the prime mover shaft being positioned in an off-set configuration.

11. A kinetic energy utilization transmission system for providing auxiliary power to a motor vehicle having a prime mover, a prime mover shaft, a vehicle change gear transmission having a range of high to low gear ratios, vehicle transmission shafting, and a braking mechanism, said system comprising:
a self-contained modulator mounted on the vehicle transmission shafting, said modulator unit comprising a rotatable modulator rotor configured to be engaged to and disengaged from the vehicle change gear transmission, induction means for providing inductive energy to the modulator unit, and flywheel means located in spaced relation to and between the modular rotor and the induction means for the storage of kinetic energy to be inputted to the vehicle via the vehicle change gear transmission, whereby the induction means provides inductive energy which results in the rotation of the flywheel means in tandem with the modulator rotor.

12. The kinetic energy utilization transmission system as in claim 11 further comprising an air gap between the modulator rotor and the modulator induction means, wherein the inductive energy from the induction means flows across the air gap to the modulator rotor, causing the rotation of the flywheel means in tandem with the modulator rotor.

13. The kinetic energy utilization transmission system as in claim 11 wherein the induction means comprises a fixed induction coil.

14. The kinetic energy utilization transmission system as in claim 11 further comprising clutch means for the engagement and disengagement between the vehicle change gear transmission and the modulator unit.

15. The kinetic energy utilization transmission system as in claim 14 wherein the vehicle transmission shafting comprises a transmission shaft, the modular unit being mounted on the transmission shaft between the prime mover shaft and the vehicle change gear transmission, such that the vehicle change gear transmission, the clutch means, the modulator unit and the prime mover shaft are positioned in an in-line configuration.

16. The kinetic energy utilization transmission system as in claim 14 wherein the vehicle transmission shafting comprises a modulator shaft and interconnected off-set transmission shafting, the modulator unit and clutch means being mounted on the modulator shaft and the vehicle change gear transmission and prime mover shaft being interconnected with the off-set transmission shafting, the modulator unit and the clutch means, and the vehicle change gear transmission and the prime mover shaft being positioned in an off-set configuration.

17. The kinetic energy utilization transmission system as in claim 11, whereby upon actuation of the braking mechanism, the modulator unit is accelerated by the step-by-step downshifting from high to low gear ratios of the vehicle change gear transmission, to provide auxiliary power to the vehicle in the form of kinetic energy.
